(19) United States
(12) Patent Application Publication
(10) Pub. No.: US 2025/0369593 A1
(43) Pub. Date: Dec. 4, 2025

(54) VISIBLE LIGHT REFLECTOR AND RELATED METHODS

(71) Applicant: Hot Rod Cameras, LLC, Burbank, CA (US)

(72) Inventor: Illya Kode, Lake Oswego, OR (US)

(21) Appl. No.: 19/219,319

(22) Filed: May 27, 2025

Related U.S. Application Data
(60) Provisional application No. 63/652,768, filed on May 29, 2024.

(51) Int. Cl. F21V 7/28; F21V 5/04; F21V 7/24; F21V 17/10; G03B 17/56

(52) U.S. Cl. CPC F21V 7/28; F21V 5/046; F21V 7/24; F21V 17/105; F21V 17/107; G03B 17/56

(57) ABSTRACT

A light reflector includes a reflector body that is opaque and has a front surface. The light reflector further includes a coating applied to the front surface of the reflector body. The coating is configured to reflect and diffuse light from one or more light sources. One or more of the light reflector body or the coating comprises a ferromagnetic material. While a single reflector body can be used, optionally two or more light reflectors can be combined using, for example, magnetic forces to form a single light reflector unit having two or more light reflectors.

### CROSS REFERENCE TO RELATED APPLICATIONS

This application claims priority to U.S. Provisional Patent Application Ser. No. 63/652,768, filed May 29, 2024, the entirety of which is hereby incorporated herein by reference for all purposes.

### FIELD OF ART

The present disclosure is generally directed to lighting equipment and related methods thereof.

### BACKGROUND

In photography, videography, or cinemaphotography, it is desirable to light the subject with reflected soft light, which create a more appealing natural appearance as compared to hard light. To achieve this desired natural appearance, the photographer or videographer typically sets up a main light source and one or more light reflectors or “bounces” that reflect the source light onto the subject, thereby indirectly lighting the subject with soft light that has a differing angle and softer shadowing than that of the source light. A typical light reflector is a collapsible disc that is made from a reflective fabric stretched across a collapsible wireframe. The reflective disc may be handheld or be mounted on a stand. Other prior art lighting devices for creating soft light include soft boxes and ring lights.

Most lighting devices for creating soft light are typically designed to be portable, collapsible, and lightweight, allowing the user to easily transport, setup and reposition, and thereafter tear down the devices. These prior art lighting devices are accordingly composed of lightweight materials, such as polymers and fabrics. Though useful, these lighting devices are typically not durable and thus are prone to breakage and surface damage. Additionally, these lighting devices may not be capable of mounting lights or other equipment thereon due to their lightweight structure.

### SUMMARY

Broadly speaking, aspects of the invention are directed to lighting equipment for lighting one or more subjects. The lighting equipment can include a metallic substrate or base with a coating thereon to reflect and diffuse light from one or more light sources, and therefore acts as a light reflector. Optionally, the light reflector, being made from a structurally rigid material, can support one or more auxiliary devices directly mounted thereon, such as additional lights or diffractors. Various components can be incorporated with the lighting equipment to provide useful functionalities for the user. Further, auxiliary devices can attach to the light reflector using a quick to assemble and dissemble magnetic mount, which only requires bringing the auxiliary device close to the light reflector for the magnetic attraction to take over.

In one embodiment, there is provided a light reflector including a reflector body. The reflector body is opaque and has a front surface. The light reflector can further include a coating applied to the front surface of the reflector body. The coating is configured to reflect and diffuse light from one or more light sources. One or more of the reflector body or the coating comprises a ferromagnetic material

In some such embodiments, the light reflector further includes one or more lighting devices removably connected to the front surface of the light reflector, which can embody any number of auxiliary devices for photography, videography, and cinemaphotography, which can collectively herein be referred to as imaging.

Alternatively or additionally, in some such embodiments, the light reflector is configured to reflect the reflected light along a reflected light axis, and each lighting device is configured to emit light along an artificial light axis that is parallel to the reflected light axis of the reflected light from the reflector body, thus simultaneously mixing the reflected light and the artificial light from each lighting device to create a mixed lighting effect on a subject. The reflected light axis is understood as an axis that that projects generally orthogonally to the front surface of the reflector body. Emitted artificial light can project parallel to the reflected light axis and be common with the reflected light axis when artificial light is emitted within the reflected light axis.

Alternatively or additionally, in some such embodiments, each lighting device includes a housing, a light housed within the housing, and one or more magnets disposed within the housing and configured to magnetically engage with the reflector body to removably connect the housing onto the front surface of the reflector body.

Alternatively or additionally, in some such embodiments, the light reflector further includes a diffractor removably connected to the reflector body. The diffractor is configured to create a shadow within the reflected light, accordingly, forming an umbra, penumbra, and antumbra in the reflected light.

Alternatively or additionally, in some such embodiments, the diffractor is magnetically connected to the reflector body.

Alternatively or additionally, in some such embodiments, the reflector body further comprises a diffractor hole, the diffractor comprises an annular head and a rod extending rearwardly from the head, the rod of the diffractor is configured to extended through the diffractor hole of the reflector body when the diffractor is assembled to the reflector body, and the diffractor is configured to be adjustable by sliding the rod relative to the reflector body to accordingly translate the head closer to or further away from the front surface of the reflector body to thereby respectively increase or decrease the size of the shadow created by the diffractor. In some examples, there can be more than one diffractor hole incorporated with the reflector body.

Alternatively or additionally, in some such embodiments, the reflector body comprises steel.

Alternatively or additionally, in some such embodiments, the coating defines a matte finish.

Alternatively or additionally, in some such embodiments, the coating comprises an adhesive, a plurality of first reflective particles, and a plurality of second reflective particles which are less reflective than the first reflective particles.

Alternatively or additionally, in some such embodiments, the coating comprises a paint containing the ferromagnetic material.

Alternatively or additionally, in some such embodiments, a light source is coupled to a backside of the light reflector, the light source having a light emitting portion configured to illuminate at least a portion of a front side of the light reflector.

In another embodiment, there is provided a lighting system including a plurality of light reflectors. Each light reflector includes a reflector body, the reflector body being opaque and having a front surface and a back surface, and a coating applied to the front surface of the reflector body, wherein one or more of the reflector body or the coating comprises a ferromagnetic material. The coating is configured to reflect and diffuse light from one or more light sources. The lighting system further includes a bracket assembly that includes at least one bracket configured to removably connect to the back surface of each light reflector and secure the plurality of light reflectors together to form a light reflector unit.

In some such embodiments, the at least one bracket comprises a bracket body and a plurality of magnets internally disposed within the bracket body, the plurality of magnets configured to magnetically engage with the plurality of light reflectors to removably connect the at least one bracket to the plurality of light reflectors.

Alternatively or additionally, in some such embodiments, the reflector body of each light reflector of the plurality of light reflectors comprises fastener holes configured to receive fasteners therethrough, and the at least one bracket further comprises a plurality of mounting holes within the bracket body. The plurality of mounting holes in the bracket body are configured to align with the corresponding fastener holes of the corresponding light reflectors for receiving fasteners therethrough for fastening the at least one bracket to the plurality of light reflectors.

Alternatively or additionally, in some such embodiments, the bracket assembly includes a main mounting bracket configured to couple corners of adjoining light reflectors of the plurality of light reflectors. The main bracket comprises an attachment point that is configured for connecting the light reflector unit to a support structure.

Alternatively or additionally, in some such embodiments, the bracket assembly further includes at least one secondary mounting bracket configured to couple sides of the adjoining light reflectors of the plurality of light reflectors.

Alternatively or additionally, in some such embodiments, the lighting system further comprises a yoke mounted to the lighting system with a bracket comprising a releasable clamp.

Alternatively or additionally, in some such embodiments, the yoke comprises a stand mount.

Alternatively or additionally, in some such embodiments, the lighting system further comprises a handle coupled with the bracket.

Alternatively or additionally, in some such embodiments, the lighting system further comprises a magnetically attached handle.

Alternatively or additionally, in some such embodiments a first light reflector of the plurality of light reflectors is attached to a second light reflector of the plurality of light reflectors with a hinge mechanism.

Alternatively or additionally, in some such embodiments the hinge mechanism is magnetically attached to the first light reflector and the second light reflector.

### BRIEF DESCRIPTION OF THE DRAWINGS

These and other features and advantages of the present devices, systems, and methods will become appreciated as the same becomes better understood with reference to the specification, claims and appended drawings wherein:

FIG. 1 is a front perspective view of a light reflector which includes a reflector body, a coating on the front surface of the body, and an optional diffractor for reflecting and diffusing light from a primary light source, in accordance with aspects of the invention.

FIG. 2 is a schematic view of the light reflector of FIG. 1, illustrating the coating on the reflector body.

FIG. 3 is a front perspective view of another embodiment of a light reflector which further includes lighting devices connected to the front surface of the reflector body, in accordance with further aspects of the invention.

FIG. 4 is a rear perspective view of an example light reflector system which includes multiple light reflectors coupled to one another by a bracket assembly to form a larger light reflector unit, in accordance with further aspects of the invention.

FIG. 5 is a front perspective view of an example main bracket of the bracket assembly of the light reflector system of FIG. 4.

FIG. 6 is a front view of the main bracket of FIG. 5.

FIG. 7 is a rear view of the main bracket of FIG. 5.

FIG. 8 is a right side view of the main bracket of FIG. 5.

FIG. 9 is a cross-sectional view of the main mounting bracket of FIG. 5.

FIG. 10 is a front view of an example secondary mounting bracket of the bracket assembly of the light reflector system of FIG. 4.

FIG. 11 is a left side view of the secondary mounting bracket of FIG. 10.

FIG. 12 is a front perspective view of an example embodiment of a light reflector which includes an adjustable diffractor, wherein the diffractor is shown in an extended position, in accordance with further aspects of the invention.

FIG. 13 is a rear perspective view of the light reflector of FIG. 12.

FIG. 14 is a front perspective view of the light reflector of FIG. 12, wherein the diffractor is shown in a retracted position.

FIG. 15 is a rear perspective view of the light reflector of FIG. 14.

FIG. 16 is a view of a diffractor with a magnetic base attached to an example light reflector.

FIG. 17 is an example magnetic stand attachment for a light reflector.

FIG. 18 is an example magnetic stand attachment magnetically connected to two example light reflectors.

FIG. 19 shows two example light reflectors connected by example hinge mechanisms.

FIGS. 20 and 21 show front and back views of an example light source attached to an example light reflector.

FIG. 22 shows an example extended structure comprising four example light reflectors, and an example yoke connected to the extended structure.

FIGS. 23A-C show views of an example bracket comprising a releasable clamp.

FIG. 24 shows a view of an extended structure comprising twenty-eight example light reflectors.

FIG. 25 shows a view of an extended structure comprising two example light reflectors.

### DETAILED DESCRIPTION

The detailed description set forth below in connection with the appended drawings is intended as a description of the presently preferred embodiments of lighting systems for lighting one or more subjects, in accordance with aspects of the present devices, systems, and methods, and is not intended to represent the only forms in which the present devices, systems, and methods may be constructed or utilized. The description sets forth the features and the steps for constructing and using the embodiments of the present devices, systems, and methods in connection with the illustrated embodiments. It is to be understood, however, that the same or equivalent functions and structures may be accomplished by different embodiments that are also intended to be encompassed within the spirit and scope of the present disclosure. As denoted elsewhere herein, like element numbers are intended to indicate like or similar elements or features.

As used herein, the term visible light refers to the spectrum of light which the human eye can see without the aid of some device or instrument. As used herein, the term umbra refers to the innermost and darkest part of a shadow created by the diffractor. The term penumbra refers to a region of the shadow in which only a portion of the light source is obscured by the diffractor. The term antumbra refers to a region of the shadow from which the diffractor appears entirely within the reflected light beam of the reflected light from the light reflector.

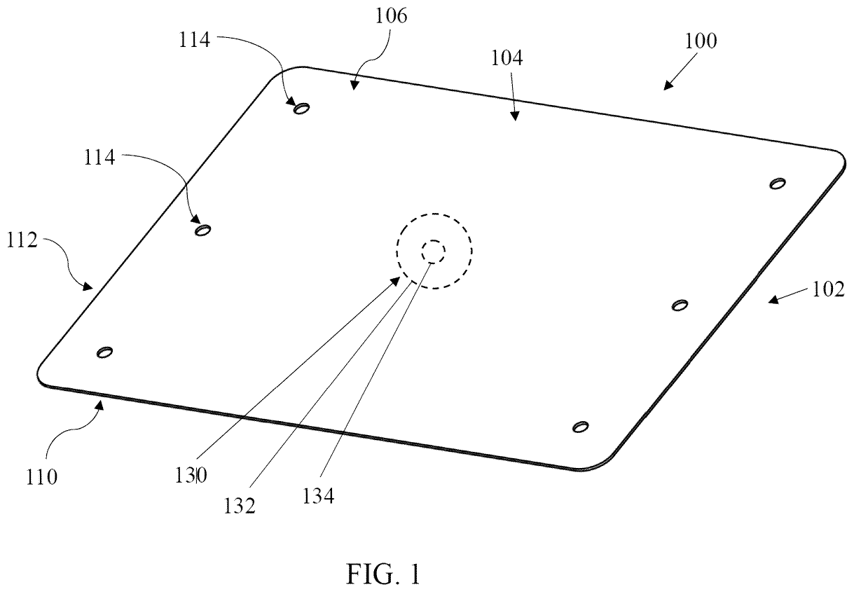

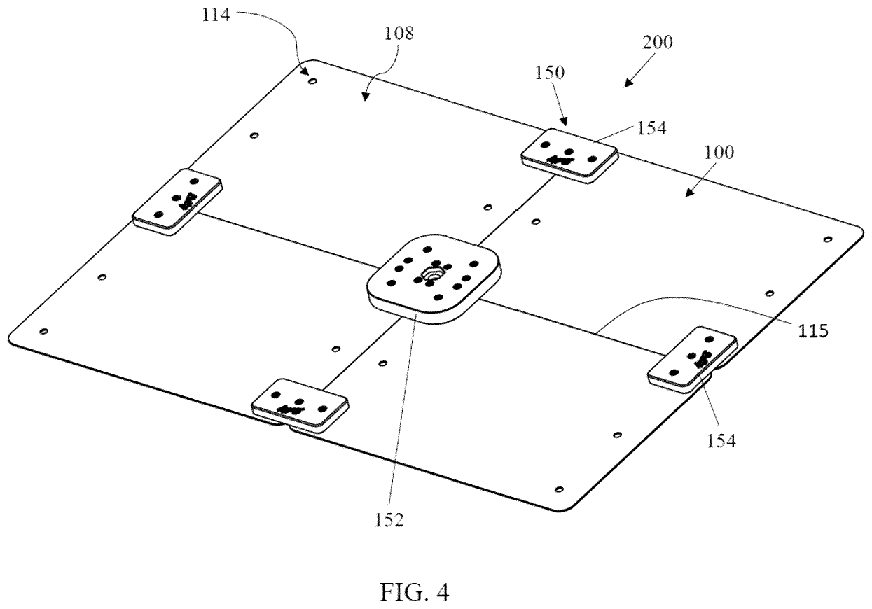

FIG. 1 illustrates an exemplary embodiment of a light reflector 100 for reflecting light from the sun, i.e., natural light, and/or any artificial light source onto a subject. The light reflector 100 can be used as a standalone reflector or be coupled to additional light reflectors 100 to form a light reflector unit 200, as discussed further herein with respect to FIG. 4. The light reflector 100 generally includes a reflector body 102 and a coating 104 applied to the reflector body 102 for receiving, redirecting, diffusing, and outwardly reflecting light.

By nature of the structure and the material composition of the reflector body 102 and the coating 104 applied to the reflector body 102, such as at least to the front surface thereof, the light reflector 100 creates a natural and appealing lighting effect on the subject(s), akin to the indirect sunlight from a window. The light reflector 100 may reflect some and preferably the full spectrum of visible light.

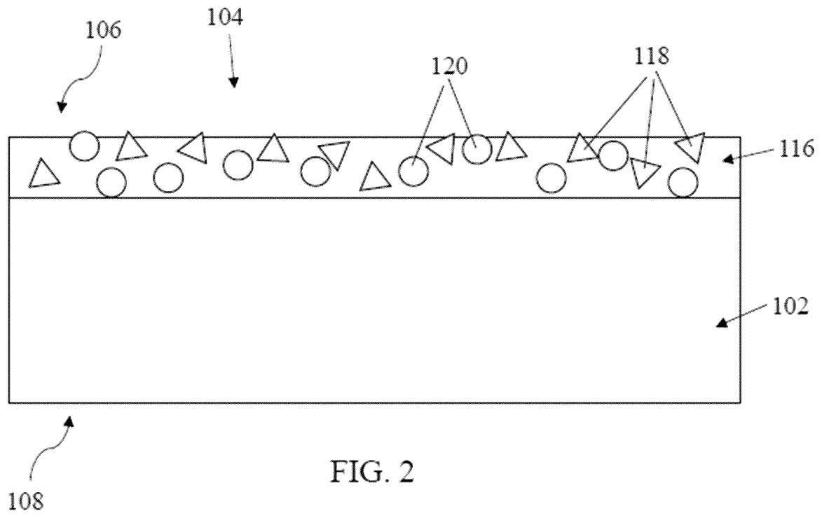

The reflector body 102 includes a front 106, a back 108 (FIG. 2), and longitudinal and lateral sides 110, 112 with corresponding surfaces thereof. In some examples, the reflector body 102 can be composed of a ferromagnetic material, such as a ferrous material (e.g. stainless steel). Alternatively or additionally, in some examples, the reflector can be coated with a coating (e.g. a paint) comprising a ferromagnetic material. Thereby, the reflector body 102 can be magnetic. As can be appreciated, stainless steel by its nature may have a relatively high reflectivity. Additionally, the reflector body 102 may be rigid, non-collapsible, and can structurally support relatively heavy objects attached to it, unlike prior art reflectors. The reflector body 102 may also be opaque to prevent light from passing therethrough, unlike canvas materials of prior art reflectors.

The reflector body 102 can comprise any desired shape, such as a substantially rectangular shape as shown or other shapes such as any number of polygonal shapes, such as square, pentagon shape, hexagon shape, etc. In one embodiment, the reflector body 102 can comprise a thin rectangular plate with rounded corners. Unlike prior art reflectors, which are typically circular or square as a result of being composed of a fabric material, and their requisite collapsible framework, the present light reflector 100 may have a rectangular body which allows for a greater range of potential axes at which light may be reflected (either positioned vertically, horizontally, or oblique). In alternative embodiments, the reflector body 102 can have differing cross-sectional shapes, widths, and sizes.

The reflector body 102 may also comprise one or more through holes 114 for mounting additional equipment, such as mounting brackets, auxiliary lights, cloth diffusion materials, etc., and/or fasteners therefor. Although shown positioned along the sides, the reflector body 102 can include any desired number of holes 114 which may be located anywhere on the reflector body 102. In one embodiment, three holes 114 may be located next to each lateral side 112 of the reflector body 102. It is noted that the holes 114 do not obstruct the reflected light. In more detail, the holes 114 create non-reflected areas corresponding to their circumference, however the non-reflected areas are invisible to the human eye because the size of each hole 114 is significantly smaller relative to the surrounding reflective surface area of the front surface of the front 106 of the reflector body 102.

Referring now to FIG. 2, there is shown a schematic cross-sectional side view of the light reflector 100 which illustrates the reflector body 102 and the coating 104 applied to the front surface of the front 106 of the reflector body 102. In an alternative embodiment, both of the front and back surfaces of the reflector body 102 may have respective coatings 104 applied thereon. The coating 104 is configured to reflect the entire spectrum of visible light, without any significant color shift. The coating 104 can be applied to the reflector body 102 via any desired application method, such as by powder coating with an electrostatic sprayer, painting, or spraying.

In an example, the coating 104 may be comprised of an adhesive 116 and a plurality of reflective particles 118, 120. The adhesive 116 may comprise any desired adhesive, such as triglycidyl isocyanurate (TGIC). The adhesive 116 can be cured by any desired curing method, such as by heat or UV curing. The reflective particles 118, 120 may comprise metallic, glass, and/or synthetic, e.g., polymer, particles. The reflective particles 118, 120 may comprise a single particle type or may comprise multiple differing particle types, with two different types shown but may incorporate a different number. In one embodiment, the coating 104 may include a plurality of first reflective particles 118 and a plurality of second reflective particles 120 having different characteristics. In an example, the second reflective particles 120 are less reflective than the first reflective particles 118. The first reflective particles 118 can be matte finish polyester particles and the second reflective particles 120 can be lower sheen or higher gloss polyester particles. The refractive index of the reflective particles 118, 120 may range from 1.3 to 4. The reflective particles 118, 120 can be approximately 35 microns, plus or minus 20 microns. The coating 104 may be any desired coating with any desired reflectivity, color bias, and light beam diffusion. Further, in some examples, the coating can comprise a ferromagnetic material to allow for magnetic attachment of accessories, as described below.

Due to the reflective particles 118, 120, the coating 104 may define a matte finish. Additionally, the coating 104 can have a micro texture, as shown by the outermost particles 118, 120 in FIG. 2 that collectively create a textured surface, which can provide for a highly directional and semi-diffuse reflection of the light. Additionally, the diffusion effect, as a result of the micro texture of the coating 104, can hide the holes 114 incorporated with the reflector body 102 within the beam of reflected light and making them invisible. It is believed that the increased diffusion scatters enough light to compensate for the non-reflective areas created by the holes 114 themselves and making them invisible. Furthermore, the micro texture of the coating 104 makes the light reflector 100 more durable in that the light reflector 100 can sustain more surface damage, smudges, abrasions from foreign objects, or oil spots from users touching the front surface, as compared to prior art reflectors which are made from fabric or aluminum and thereby are highly susceptible to damage and smudges. For instance, prior art reflectors made from aluminum are suboptimal because aluminum has a crystalline surface (with slight disruptions therein) that is highly susceptible to any surface damage. For example, since the crystalline surface of aluminum creates a coherent (less diffused) reflected beam of light, any smudges, foreign objects, or skin oil on the crystalline surface can cause noticeable imperfections in the coherent reflected beam of light. In contrast to prior art reflectors made from fabrics or aluminum, the present light reflector 100 is more durable and creates a more robust reflected beam of light because of its textured coating 104, which are less susceptible to smudges, foreign objects, and/or skin oil.

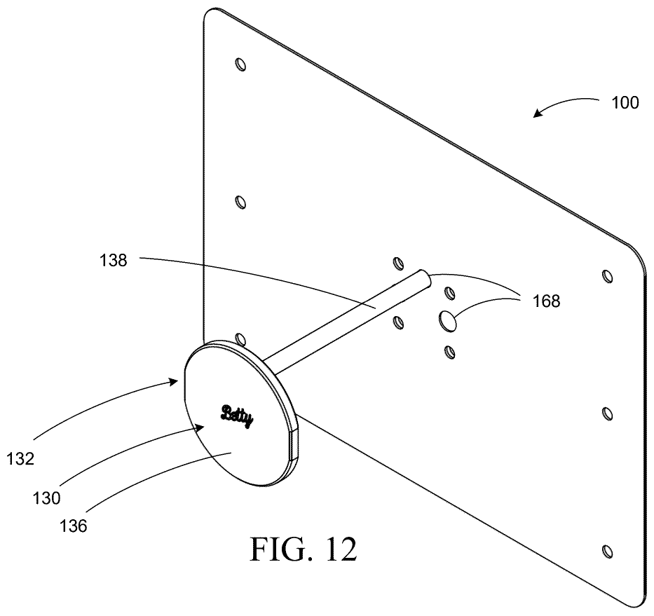

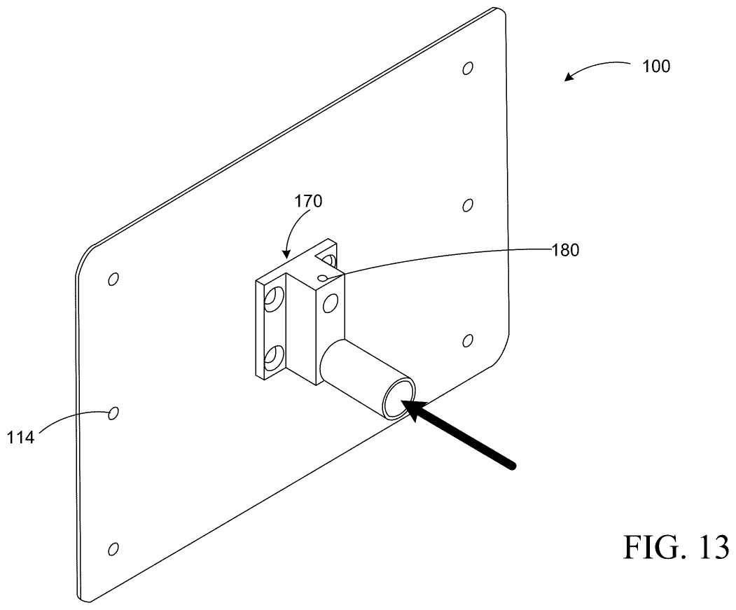

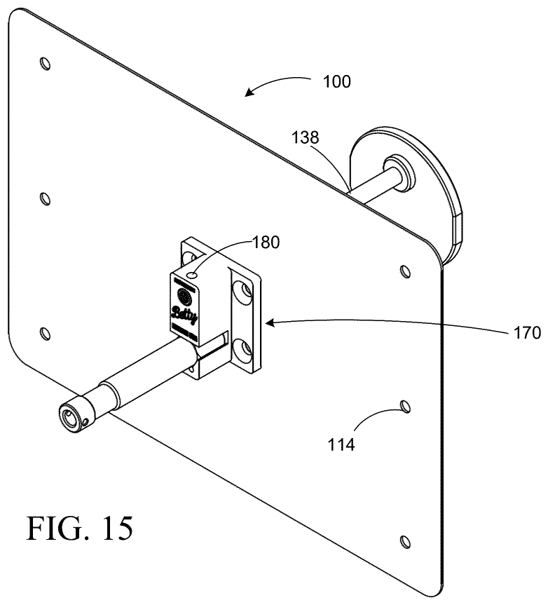

Optionally, the light reflector 100 can include one or more removable diffractors 130 (or light blockers) (FIG. 1) that can be removably connected to the front surface of the reflector body 102. Each diffractor 130 can block, i.e., prevent, a certain amount of light to accordingly create a shadow in the reflected light beam emanating from the reflector body 102. The diffractor 130 can comprise any desired shape and size, which can alter the shadow effect desired by the user. The diffractor 130 may comprise a body 132 and one or more magnets 134 attached to the body 132. In an example, the magnet is internally disposed within its body 132 (FIG. 1). Since the reflector body 102 has a ferrous component and is magnetic, the magnet(s) 134 may magnetically couple the diffractor 130 anywhere on the front surface of the reflector body 102. The magnets 134 may comprise neodymium magnets with other magnet types contemplated. As discussed below with respect to FIGS. 12-15, the diffractor 130 may be configured as an adjustable diffractor 130 with a cover head 136 and a rod 138. In some embodiments, the rod 138 may be a rigid rod. In some embodiments, the rod 138 may be a telescoping rod. The telescoping rod allows the diffractor 130 to be adjustable by giving the user the ability adjust the position of the cover head 136 by collapsing or extending the rod 138.

Typically, with prior art reflectors, if a user wanted to create a shadow within a reflected beam of light, the user had to set up a device, such as a gobo or cucoloris, on a separate stand in front of the reflector, with additional anchor weights on the base of the stand to support the overhang. As can be appreciated, the present light reflector 100 allows the user to more easily and efficiently add, remove, or reposition the one or more diffractors 130 in comparison to prior art reflectors by simply magnetically attach and directly mount the one or more diffractors onto the front surface of the reflector body 102 without any additional stands. Thus, an aspect of the invention includes the ability to attach a diffractor 130 to a light reflector 100 without using any fastener, mechanical or otherwise, although fasteners may be used as a redundant system.

Additionally, prior art shadow-creating devices do not create a deliberate umbra, penumbra, or antumbra in the reflected light. In contrast to prior art gobos or other devices, the present diffractor 130 creates a shadow within the reflected light, which creates an umbra, penumbra, and antumbra in the reflected light. In more detail, since the ferrous reflector body 102 and the coating 104 thereon dually creates highly directional and semi-diffuse reflection of the light, the resulting shadow created by the diffractor 130 provides an umbra, a penumbra, and an antumbra, which a viewer can see depending upon the viewer's relative position to the diffractor 130. Without the diffraction provided by the coating 104, only an umbra would be created. Thus, the combination of the ferrous reflector body 102, the coating 104, and the diffractor 130 creates a unique, subtler lighting effect as compared to either traditional direct or a reflected “right light” from known prior art lighting equipment, such as ring lights or a bounce that has a missing center section. Furthermore, as mentioned above, the coating 104 is advantageously durable which allows the diffractor to directly contact the coating 104, repeatedly, without causing unwanted imperfections in the reflected light beam.

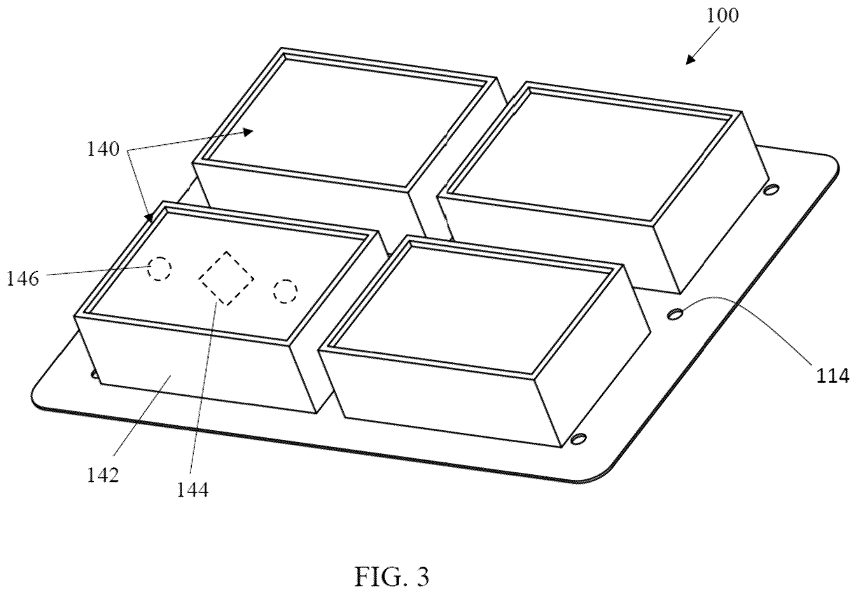

Referring now to FIG. 3, there is shown a front perspective view of a light reflector 100 with one or more lighting devices 140 removably mounted onto its front surface. Each lighting device 140 includes a housing 142, at least one light or light source 144 housed within the housing 142, and one or more magnets 146 disposed within the housing 142. Each light 144 may be any desired light, such as a light emitting diode (LED) light or a xenon gas-based light. The magnets 146 of the lighting device 140 can be configured to magnetically engage with the reflector body 102 to removably connect, and rigidly secure, the housing 142 onto the front surface of the reflector body 102.

Since the lighting devices 140 are mounted onto the front surface of the reflector body 102, the artificial light beams are emitted from the lighting devices 140 on the exact same axis as the reflected light beam of the reflector body 102. Additionally, due to the mounting location of the lighting devices 140 directly on the front surface of the reflector body 102, the resulting beam of light is a mixed beam of light that seamlessly combines the reflected light beam and beam(s) of light from the lighting device(s) 140. In more detail, when the lighting devices 140 are equipped with the light reflector, the reflector body 102 is still configured to reflect light (via the exposed areas of the reflector body not covered by any lighting devices 140) along a reflected light axis, and each lighting device 140 is configured to emit light along an artificial light axis that is parallel to the reflected light axis of the reflected light from the reflector body 102, thus simultaneously mixing the reflected light and the light emanating from each lighting device 140 to create a mixed lighting effect on a subject. Since the aforementioned beams of light are mixed, without affecting the color of the incoming light, and share a common axis, their combined reflected and radiating light creates a far more natural and appealing lighting effect on the subject(s) as compared to separately mounted prior art lighting devices. Thus, an aspect of the present invention is understood to include a method of emitting both a direct emanating beam of light and a reflected beam of light from a common axis to a subject to be imaged. The two beams are mixed when converged onto the subject. The direct emanating beam and the reflected beam can originate from the same combined structure in which at least one magnet is used.

Traditionally, it can be difficult to combine multiple lighting sources to create a mixed lighting effect on the subject. With prior art devices, to create mixed lighting, a user must generally mount an auxiliary lighting device next to a prior art reflector or bounce (using a separate stand). Since the lighting device is mounted off-axis relative to the reflector, the light from the lighting device and the reflector are off-axis from one another and thereby can create unappealing shadows on the subject. Additionally, the prior art teaches reflectors that are lightweight and easy to transport, which accordingly limits the material choice of the reflectors. Thus, most reflectors are made of a canvas material for the lightweight and collapsibility or thin gauge aluminum for lightweight properties. By nature of being lightweight and easily transportable, such prior art reflectors are not intended nor contemplated to support additional lighting devices. Among other things, the canvas material would collapse or distort if a weighted material is mounted thereon and the thin gauge aluminum reflector would require beefing up in order to support additional weight from the lighting device thereby defeating the purpose of being lightweight. Thus, prior art devices are not configured for supporting the weight of additional lighting devices. Furthermore, due to the structure of prior art reflectors, such reflectors, or framework thereof, are not configured to receive mounting bracketry that could mount or support auxiliary lighting devices.

As shown in FIG. 3, the lighting devices 140 are directed outwardly away from the front of the reflector body 102 for shining light away from the reflector body 102. However, in an alternative embodiment some or all of the lighting devices 140 may be rearwardly oriented such that they shine light onto the reflector body 102. For example, in one embodiment, one lighting device 140 may be magnetically connected to the reflector body 102 and oriented outwardly, and another lighting device 140 may be attached to the reflector body 102 and oriented inwardly toward the reflector body 102. It is conceivable that the lighting devices 140 may be mounted on the reflector body 102 and be oriented in any desired position. In an example, the lighting device 140 may include a second set of one or more magnets for mounting the lighting device in an orientation to emit light toward the reflector body. For example, magnets can be placed along the front perimeter of the housing 142 to magnetically attract the magnetic material of the reflector body. Alternatively, fasteners may be incorporated with the housing 142 to attach the lighting device to the one or more through holes 114 on the reflector body.

In one embodiment, additional lighting devices 140, and any mounting brackets and/or magnets therefore if needed, may be mounted directly on the diffractor 130 instead of or in addition to mounting directly to the reflector body 102. For example, an additional lighting device 140 may be mounted on the front of the diffractor 130 and be forwardly oriented such that the light from the lighting device 140 is directed outwardly away from the reflector body toward the subject. Additionally, for example, an additional lighting device 140 may be connected to a side or rear of the diffractor 130 and be rearwardly oriented such that the light from the lighting device 140 is directed inwardly toward the front surface of the reflector body 102 and the light is reflected off of the reflector body toward the subject. In one embodiment, the light reflector 100 may predominately, or even completely,

function as a light stand. For example, the light reflector 100 may be used to mount multiple lighting devices 140 such that very little surface area is left exposed, which equates to very little, to no light, being reflected off of the reflector thereby limiting its functionality to being just a support stand. Additionally, for example, a user may forego utilizing a remote main light source such that the only light on the subject comes from the lighting devices 140 mounted on the light reflector 100, which is used as a support stand. In some examples, the lighting devices 140 do not cover all of the front surface of the reflector body so that the fixture has both direct emitting light beam as well as reflected light beam, all passing along a common axis.

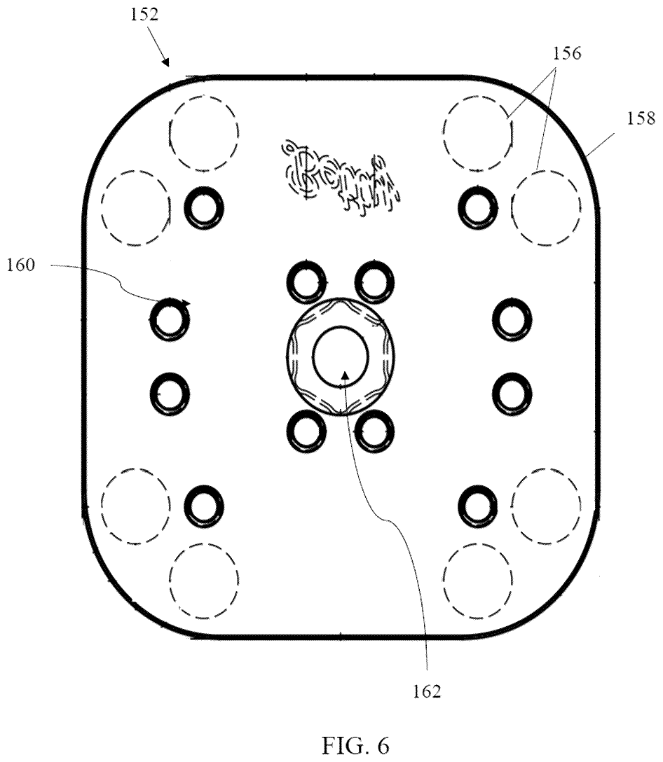

FIG. 4 illustrates an example of a lighting system in the form of a modular light reflector unit 200, which is formed by coupling two or more light reflectors 100 together via a bracket assembly 150. The bracket assembly 150 includes at least one bracket 152, 154 that connects to the back surface of two adjacent light reflectors 100 via magnets 156. In an example, each bracket is embedded in an outer cover, such as a plastic outer cover, and the magnets are disposed within the outer cover of the body 158 (FIG. 6). In another embodiment, the bracket is only partially covered by an outer cover. Alternatively or additionally, fasteners may be used by providing a plurality of through fastener holes 160 through the body so that bolts and nuts may selectively be used to secure the bracket in any orientation as desired for fitment. Thereby, a user can easily and quickly assemble multiple light reflectors 100 together by connecting the bracket(s) 152, 154 thereto to form a single integrated rigid light reflector unit 200, formed from multiple smaller light reflectors, to accordingly reflect even more light from the one or more main light sources. Additionally, the user can easily and quickly disassemble the light reflector unit 200 by reverse operation, allowing the light reflectors 100 to be easily transported. The light reflectors 100 which form the light reflector unit 200 may or may not have additional lighting devices 140 and/or diffractors 130 connected thereto. When assembled, the light reflector unit 200 has a plurality of through seams 155, which may be closed up by contacting the side edges of adjacent light reflectors and held by magnets and/or fasteners.

Advantageously, the bracket assembly 150 only connects to the back surface of the back 108 of the light reflectors 100, and thereby the bracket assembly 150 does not interfere with the light being reflected from the light reflector unit 200. For example, when relying only on magnets to assemble two or more light reflectors 100, the magnets will secure the various reflector bodies together without exposing any part of the bracket assembly at the front of the light reflector unit. In the event fasteners are used, any fasteners at the front surface of the reflector body 102 will be hidden by the reflected light due to the micro texture of the coating 104, as previously discussed. Also, because the bracket assembly 150 only connects to the back surface of the light reflectors 100, the user can add any desired auxiliary lighting devices 140 and/or diffractors 130 anywhere on the front surface of the light reflector unit 200, without obstruction from the bracket assembly 150. Furthermore, since the bracket assembly 150 only connects to the back surface of the light reflectors 100, the light reflectors 100 can rest flush with one another such that the opposed sides of adjacent light reflectors 100 can face and engage with one another. Thus, no gaps exist between the adjoined light reflectors 100 which would otherwise cause disruptions or shadows in the reflected light emanating from the light reflector unit 200.

In one embodiment, each bracket 152, 154 may comprise magnets 156 and fastener holes 160 for securing the bracket 152, 154 to the light reflectors 100. Therein, the bracket body 158 may include multiple through holes 160 that correspond to the through holes 114 of the corresponding reflector bodies 102 of the light reflectors 100, in both size and shape. Thereby, the bracket body 158 may be initially coupled to the light reflectors 100 via a magnetic connection and subsequently secured via fasteners, such as screws or nuts and bolts, which extend through the holes 160 in the bracket body 158 and the reflector bodies 102, thus forming the rigid light reflector unit 200. In an alternative embedment, each bracket 152, 154 may only comprise magnets 156 for securing the light reflectors 100 together. In another alternative embodiment, each bracket 152, 154 may not include internally disposed magnets, relying instead on only mechanical fasteners. Using magnets can initially align the reflector bodies together and then fasteners may be used to more rigidly secure the reflector bodies together to form the light reflector unit 200. However, when using strong magnets, such as neodymium (Nd) magnets, fasteners may be omitted.

The bracket body 158 may comprise any desired shape and material. The magnets 156 may be positioned within magnet recesses in the bracket body 158. The magnets 156 may or may not be exposed such that the magnets 156 may or may not directly contact the reflector body 102. In one embodiment, the magnets 156 may be covered by an outer sidewall cover of the bracket body 158. The magnets 156 may be neodymium magnets. Optionally, samarium cobalt magnets, alnico magnets, or ferrite magnets may be used.

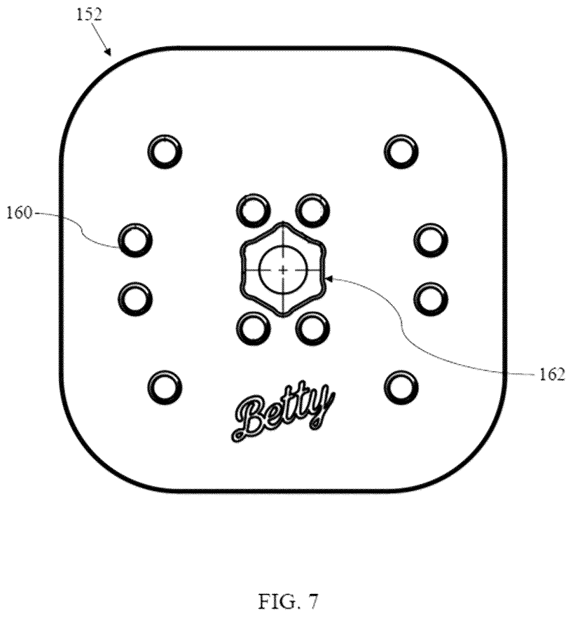

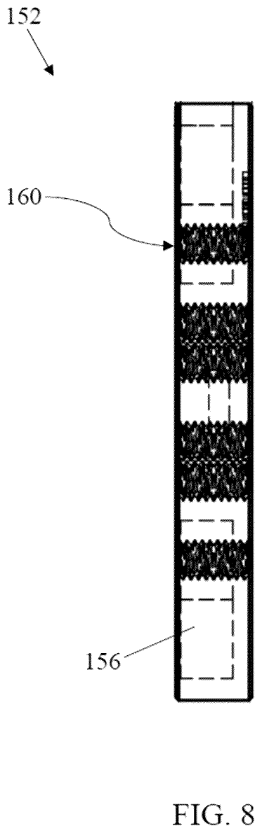

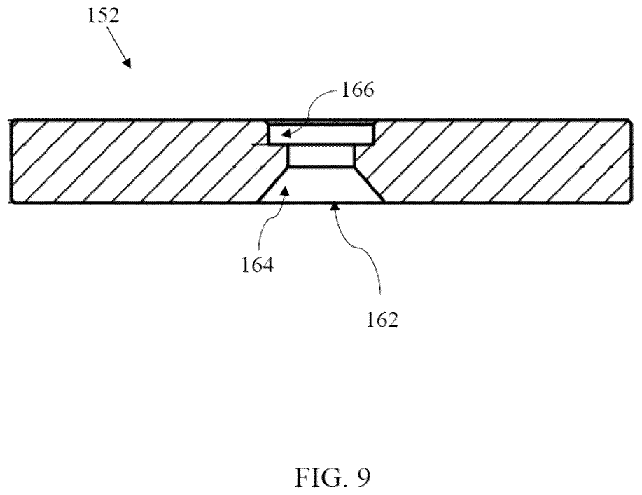

Referring collectively to FIGS. 4-11, in one embodiment, the bracket assembly 150 one or more bracket types depending on the array of light reflectors to be assembled to form the light reflector unit. As shown, the bracket assembly 150 includes a single main mounting bracket 152 and one or more, e.g., four, secondary mounting brackets 154 that span across adjacent light reflectors 100. The main mounting bracket 152 and the secondary mounting brackets 154 may or may not differ in size and shape. As shown, the main mounting bracket 152 is larger and configured to couple one each of four corners of four adjoining light reflectors 100, whereas the secondary mounting brackets 154 are each smaller than the main mounting bracket 152 and are configured to couple the sides of two adjoining light reflectors 100. Obviously, the selection of mounting bracket types for joining adjacent light reflectors can vary as desired by the user.

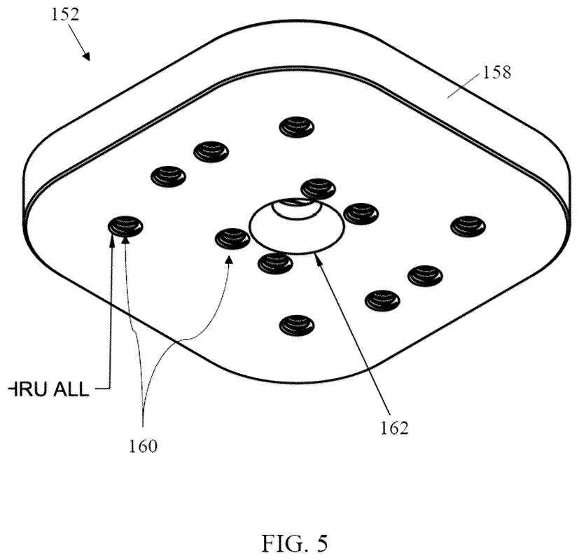

As shown in FIGS. 5-9, the main mounting bracket 152 may comprise a multi-sided body, such as a square plate. The body can accommodate one or more magnets 156 and can include through holes 160 for receiving fasteners therein. An attachment point 162 that acts as an anchor can be incorporate to connect the light reflector unit 200 to a support structure, such as a stand, a wall, a lighting device, scaffolding, etc. The attachment point 162 can embody a through hole that can include or one or more shoulders, recessed lip, etc. for accommodating other brackets and/or fasteners for mounting. In one embodiment, the main mounting bracket 152 has a generally square cross-section with rounded corners. However, the main mounting bracket 152 can be variously configured, such as sized and shaped. The main mounting bracket 152 may serve as a central bracket and the attachment point 162 of the light reflector unit 200 for mounting to a stand or support.

In one embodiment, the main mounting bracket 152 may include two magnets 156 disposed next to each corner of the bracket body 158, thereby including eight magnets 156 in total. Optionally, only one magnet is incorporated at each corner or at each of one or more corners. The position of the magnets 156 next to the corners increases the magnetic force that acts on the corresponding corners of the corresponding reflector bodies 102 when the light reflector unit 200 is assembled. The magnets 156 can be positioned just underneath the front outer wall of the bracket body 158. For example, the bracket body can include recesses for receiving the magnets in a recessed manner. The main mounting bracket 152 may further include multiple through holes 160, such as four, six, twelve, etc., mounting holes, for mounting one, two, three, or four reflector bodies 102 onto its bracket body 158. In some embodiments, the mounting holes 160 may be configured for mounting other lighting equipment in addition to mounting the light reflectors 100. For example, some of the mounting holes 160 may be used to secure the reflector bodies 102 together while other holes are used to secure auxiliary devices or lighting devices. The through holes 160 may or may not be threaded. The main mounting bracket 152 may further include an attachment point 162 at the center of its bracket body 158. The attachment point 162 may comprise a through hole 162 with its front opening 164 being annular and tapered and its rear opening 166 being hexagonal (FIGS. 6-7 and 9).

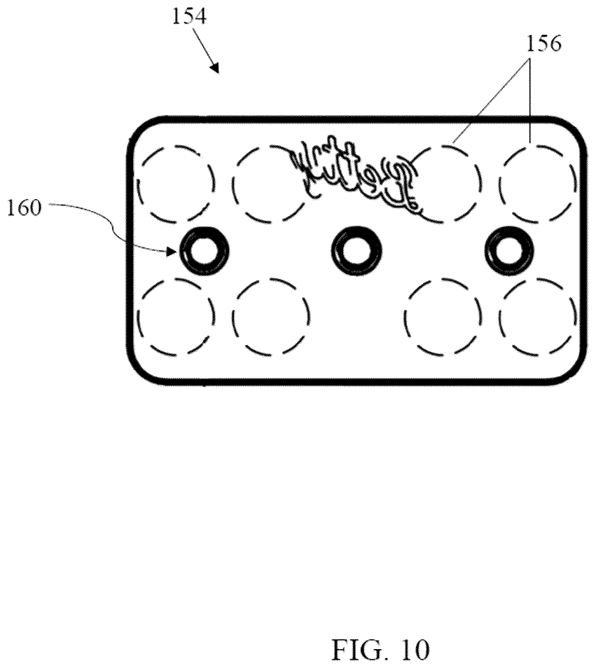

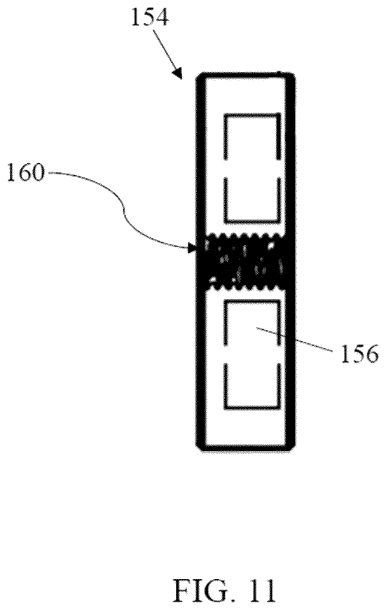

As shown in FIGS. 10-11, each secondary mounting bracket 154 may comprise a multi-sided body, such as a rectangular plate. The secondary mounting bracket may include one or more magnets 156 and one or more through holes 160 for receiving fasteners therein. In one embodiment, each secondary mounting bracket 154 has a generally rectangular cross-section with rounded corners. However, each secondary mounting bracket 154 may be variously configured, such as being sized and shaped as desired. Each secondary mounting bracket 154 may serve as a stabilizing bracket that stabilizes the edges of the light reflector unit 200.

In one embodiment, each secondary mounting bracket 154 may include four paired magnets 156 next to each lateral end of its bracket body 158, thereby including eight magnets 156 in total. Optionally, only one magnet is incorporated at each lateral end or at each of one or more lateral ends. As shown in FIG. 11, which is a left side view of the secondary mounting bracket 154, the magnets 156 can be positioned just underneath the front outer wall of the bracket body 158. For example, the bracket body can include recesses for receiving the magnets in a recessed manner. Each secondary mounting bracket 154 may include multiple through holes 160, such as two or three holes. The through holes 160 can be used with fasteners to secure with holes 114 in the reflector bodies 102 in order to securely couple the reflector bodies 102 together. The through holes 160 of each secondary mounting bracket 154 may or may not be threaded. In some examples, the through holes on the brackets and the through holes on the reflector bodies can match or correspond to facilitate alignment.

Referring now collectively to FIGS. 12-15, there is shown another embodiment of a light reflector 100 with a diffractor 130. The light reflector 100 can be substantially similar to the light reflector 100 as discussed above, except that the light reflector 100 has additional mounting features, such as one or more through holes 168 for mounting a diffractor 130 in conjunction with a rear mounting bracket 170. The rear mounting bracket 170 may be configured to couple to standard mounting hardware, such as ⅝ in. compatible female mounting hardware or a universal coupler (unnumbered). In an example, the additional through holes 168 may be incorporated near or centrally of the reflector body.

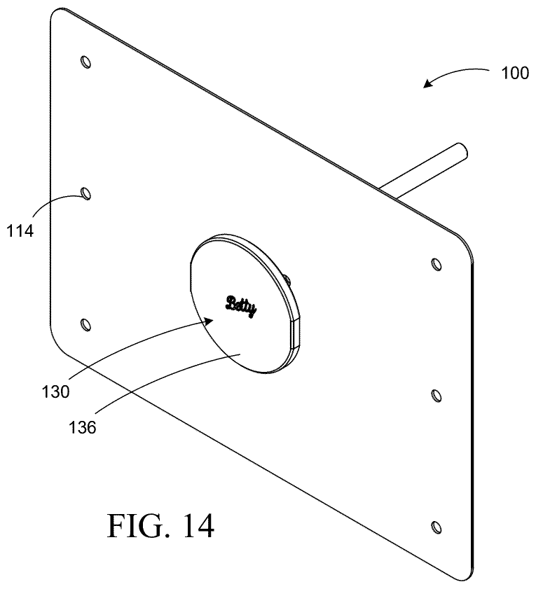

In one embodiment, the diffractor 130 is an adjustable diffractor in that its body can move relative to the front of the reflector body. As shown, the diffractor comprises a cover head 136 for creating a shadow in the reflected beam of light. One or more rods 138 can extend rearwardly from the cover head 136 which allow the user to adjust the position of the cover head 136 relative to the front of the reflector body. The relative position of the cover head 136 allows the user to alter the size and shape of the shadow created by the diffractor. The user can axially slide the cover head 136 of the diffractor 130 closer to or further away from the front surface of the reflector body 102, thereby respectively increasing or decreasing the size of the shadow created by the diffractor 130. The diffractor 130 is adjustable in between a fully extended position (FIGS. 12-13 and 15) and a fully retracted position (FIG. 14), and optionally anywhere in between. The cover head 136 may comprise any desired shape, such as a discoidal, generally circular, ellipsoidal, conical, rectangular, etc., shape. The cover head 136 should reside in front of the front surface of the reflector body 102. The one or more rods 138 of the diffractor 130 are connected to the cover head 136 and extend through corresponding diffractor holes 168 of the reflector body 102 when the diffractor 130 is assembled to the reflector body 102, and through corresponding through holes 160 in the bracket 170. In one example, only one rod 138 is incorporated to allow the cover head 168 to not only extend and retract but to also pivot about the single rod. In the fully extended position, the distal end of the rod 138 may reside within the bracket 170, and in the fully retracted position the distal end of the rod 138 may reside outside and rearwardly of the bracket 170. The diffractor 130 may comprise any desired material. The diffractor 130 may or may not comprise magnets disposed therein.

In one embodiment, the bracket 170 for use to mount the diffractor 130 may include a locking mechanism 180 to selectively hold the diffractor 130 in a desired position. The locking mechanism 180 of the diffractor 130 may comprise a locking screw, a set screw, a locking pin, indexed grooves and corresponding protrusions, a ball bearing quick coupler, a detent pin coupler, or a spring biased coupler. For example, the bracket 170 may include a locking screw and a threaded hole that opens into a receiving hole of a rear protrusion of the bracket 170. The threaded hole receives the locking screw therein. The user may selectively lock the diffractor 130 in a desired position by tightening the locking screw such that the end of the locking screw abuts the rod 138 and accordingly mechanically locks the rod 138 in the desired position. In another embodiment, the rod 138 may have indexed protrusions extending along its length and the through hole 168 of the reflector body 102 and/or the through hole 160 of the bracket 170 may have a corresponding groove or detent that selectively engages a desired groove to achieve a desired mounting position of the diffractor 130. In yet another example, a magnet can be incorporated on the rod 138 and/or the rear mounting bracket 170 and the rod can simply slide into or out of a corresponding hole on the bracket and held stationary via magnetic forces.

In one embodiment, the light reflector 100 or light reflector unit 200 can be used in conjunction with other lighting equipment. For example, the light reflector 100 or light reflector unit 200 may be combined with a gobo, cucoloris, eggcrate or grid, optics, prisms, other diffusion materials such as fabric or silicon, and/or filters or gels.

In one embodiment, the light reflector 100 can be additionally used as a light blocker. Because the reflector body 102 is opaque with a hole pattern, the light reflector 100 can also be used to “cut” or block light. The user may place the reflector 100 in front of a light source and the holes 114 may accordingly create a pattern or an out of focus area. This feature could be desirable for photography, videography, or cinematography.

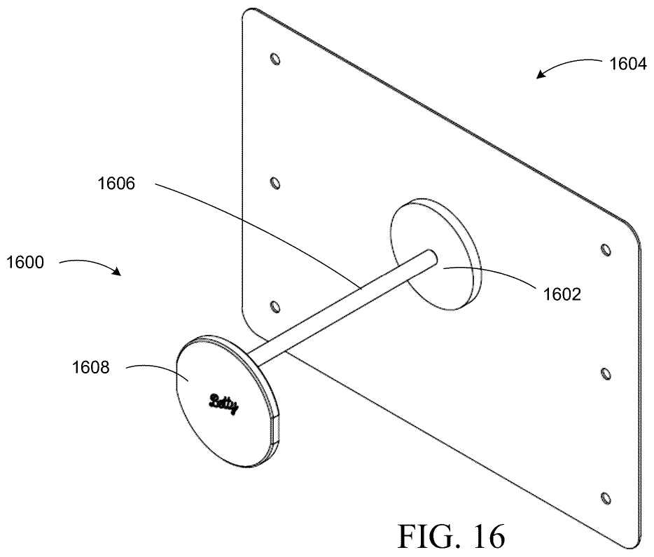

In the example of FIGS. 12-15, the diffractor 130 is coupled to the light reflector 100 using a rear mounting bracket 170 configured to receive a rod of the diffractor 130 that is inserted through a through hole 168 in the light reflector 100. In other examples, a diffractor can be attached to a light reflector using any other suitable mechanism. For example, FIG. 16 shows a diffractor 1600 mounted to a light reflector 1604 with a magnetic base 1602. In such an arrangement, the light diffractor can be mounted at any desired location on the light reflector 1604. In the example of FIG. 16, the diffractor 1600 comprises a fixed length rod 1606 to maintain a cover head 1608 at a fixed distance from the magnetic base 1602. However, in other examples, a diffractor with a magnetic base 1602 can include an adjustable rod that allows a distance between a cover head and a magnetic base of a diffractor. Example adjustment mechanisms include telescoping mechanisms with two or more segments, threaded adjustment mechanisms (in which one segment has a threaded connection to another segment so that a length can be adjusted by twisting one segment relative to another), and/or scissor mechanisms.

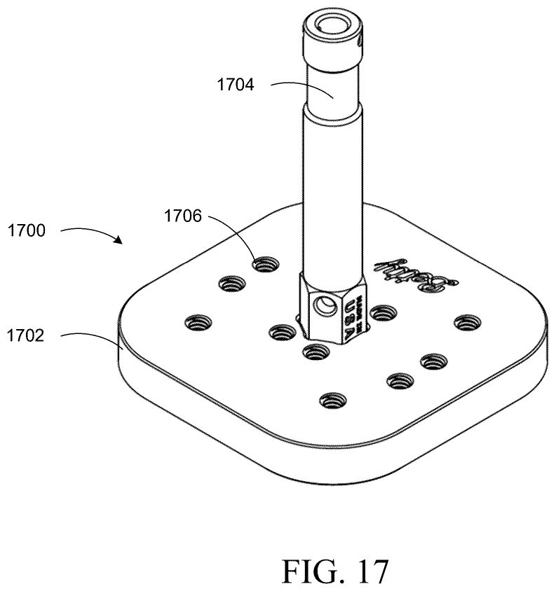

FIG. 17 shows an example of a magnetic stand attachment 1700 that can be used to attach a light reflector according to the present disclosure to a suitable lighting stand. The magnetic stand attachment 1700 includes a magnetic base 1702 comprising one or more magnets. The magnetic stand attachment 1700 further includes a bracket 1704 coupled with the magnetic base 1702 to which a complementary bracket of a lighting stand can be coupled. The magnetic base 1702 can be attached to a backside (for example) of a light reflector according to the present disclosure for attachment to a stand. The magnetic stand attachment 1700 further includes mounting holes 1706 that can attach to two light reflectors arranged side-by-side to allow both to be connected to a stand. The use of the magnetic stand attachment 1700 allows a light reflector according to the present disclosure to be quickly and conveniently mounted or dismounted from studio lighting stands. The term “stand” as used herein refers to any support for a light reflector as disclosed, such as floor stands, booms, etc.

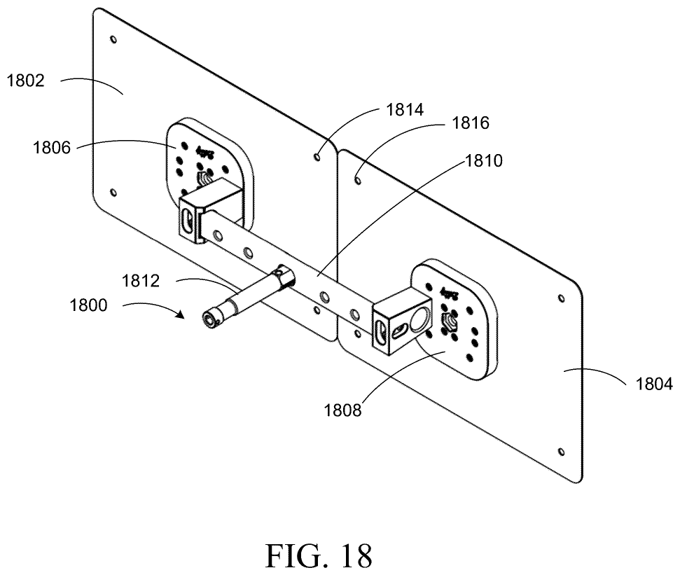

FIG. 18 shows an example in which another example magnetic stand attachment 1800 is used to support two light reflectors 1802, 1804. The magnetic stand attachment 1800 comprises a first magnetic base 1806, a second magnetic base 1808, a bar 1810 connecting the first magnetic base 1806 and the second magnetic base 1808, and a stand attachment 1812 removably coupled to the beam. The bar 1810 comprises additional mounting holes 1811 to which other attachments, such as a handle, can be attached. In other examples, a stand attachment may be integrated with a bar, rather than removably attached to the beam. In some examples, the light reflectors 1802, 1804 can be secured together by one or more brackets (not shown) that attach, for example, to adjacent through holes (e.g. through holes 1814 and 1816) of the light reflectors 1802, 1804. In other examples, the light reflectors 1802, 1804 can be secured by a different attachment mechanism, or by the magnetic stand attachment 1800 alone. In the depicted example, the first magnetic base 1806 and the second magnetic base 1808 each take the form of a main bracket as described above with regard to FIG. 5. In other examples, one or both of the first magnetic base 1806 and the second magnetic base 1808 can take a different form. Further, while the example of FIG. 5 shows two light reflectors 1800, 1802 supported by a magnetic stand attachment 1804, in other examples, a magnetic stand attachment may be configured to support three or more light reflectors.

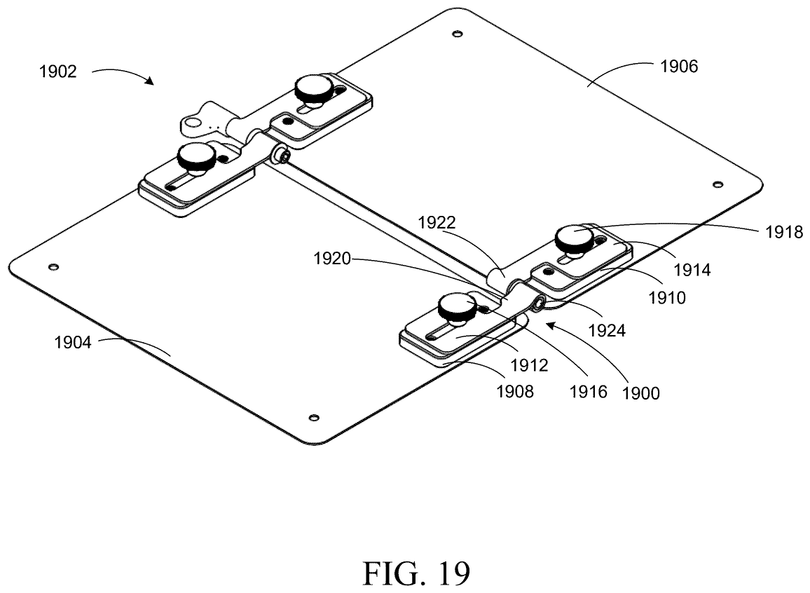

FIG. 19 shows another example mechanism for connecting adjacent light reflectors. More particularly, FIG. 19 shows example hinge mechanisms 1900, 1902 connecting adjacent light reflectors 1904, 1906. Referring to hinge mechanism 1900, each hinge mechanism includes a first base 1908 and a second base 1910. The first base 1908 and the second base 1910 are respectively connected to a first slider 1912 and a second slider 1914. The first slider 1912 is coupled to the first base 1908 with a first knob bolt 1916. The second slider 1914 is coupled to the second base 1910 with a second knob bolt 1918. The first and second sliders 1912, 1914 also include hinge ends 1920, 1922 through which a pin 1924 extends to form a hinge. The use of the first slider 1912 and the second slider 1914 allow for some a distance between the light reflectors 1904, 1906 to be adjusted when the first knob bolt 1916 and/or the second knob bolt 1918 respectively are loosened. The first knob bolt 1916 and/or the second knob bolt 1918 then can be tightened to fix the light reflectors 1904, 1906 in place. In various examples, the first base 1908 and/or the second base 1910 each can be attached to the respective light reflector 1904, 1906 by magnetic attachment and/or mechanical attachment. While two hinge mechanisms 1900, 1902 are used to couple two light reflectors 1904, 1906 in the depicted example, in other examples, any other suitable number of hinge mechanisms can be used, including one, or three or more. Further, more than two light reflectors can be attached by hinge mechanisms to form extended structures in some examples.

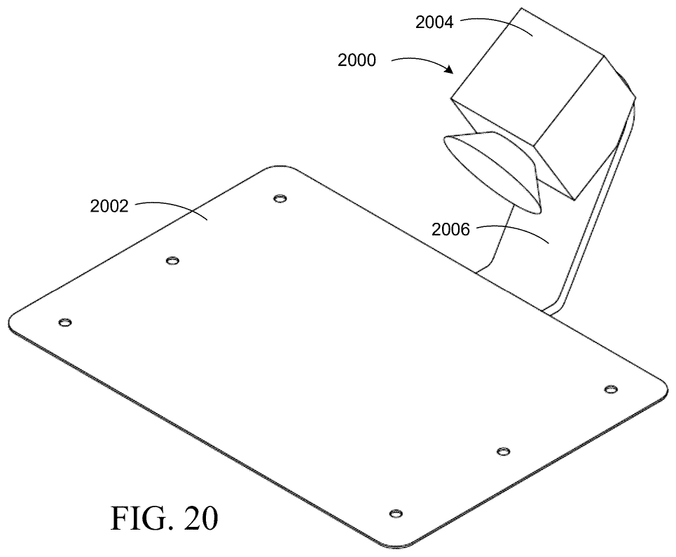

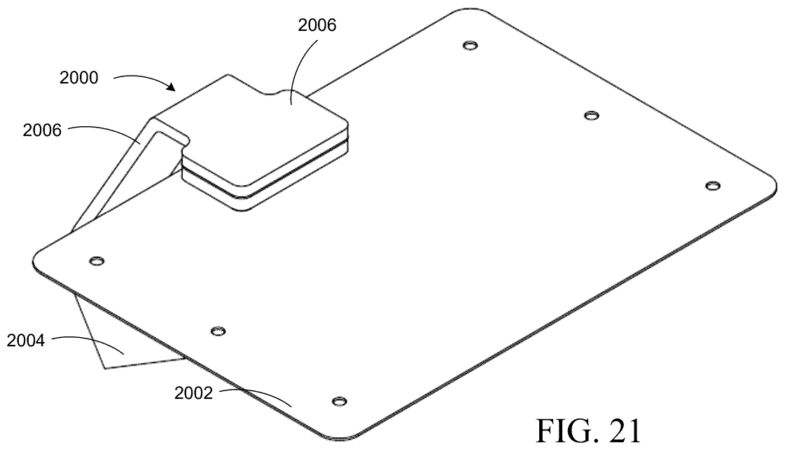

FIGS. 20 and 21 respectively show front and back perspective views of another example of a light source 2000 coupled to a light reflector 2002 according to the present disclosure. Referring first to FIG. 20, the light source 2000 comprises a light emitter portion 2004 supported by a frame 2006. The light emitter portion 2004 can comprise any suitable light source, such as one or more light emitting diodes, one or more incandescent bulbs, etc. The light emitter portion optionally can include optics to expand light emitted by the light emitter portion 2004 to cover a desired area of the light reflector 2002, whether a portion of or an entirety of the light reflector 2002. Next referring to FIG. 21, the frame 2006 comprises a magnetic base 2008 configured to magnetically attach to a backside of the light reflector 2002. The light emitter portion 2004 or the magnetic base 2008 can include a battery holder to provide power to the light source in some examples. In other examples, a power cord can be provided to plug into an outlet or other external power supply. The light source 2000 and light reflector 2002 of FIGS. 20-21 can be used, for example, as desk lighting, to illuminate a user of a webcam, to illuminate a user for self-portraits, and/or for any other suitable use. In other examples, a light source similar to light source 2000 can be configured to couple mechanically to a backside of a light reflector, in addition to or alternatively to a magnetic coupling.

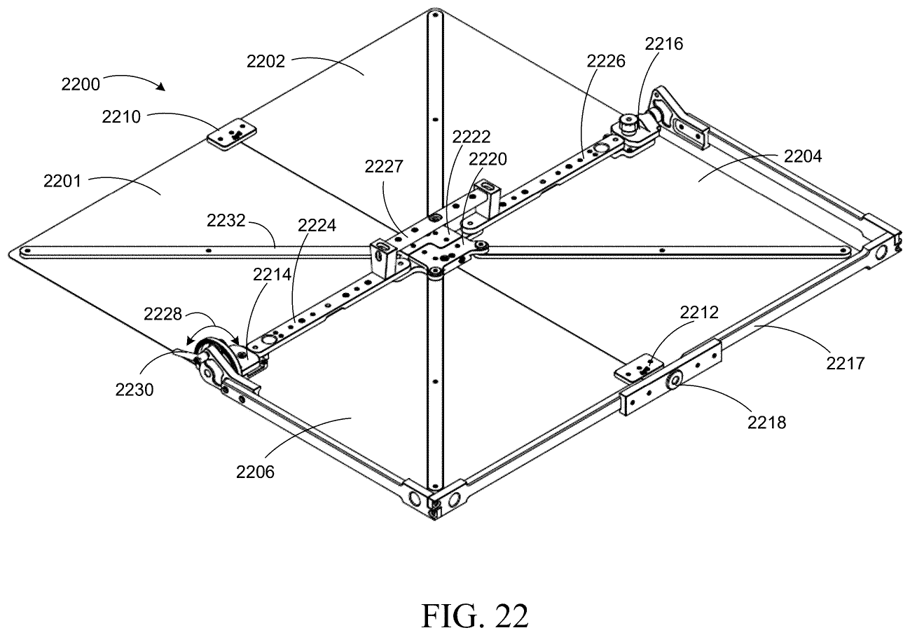

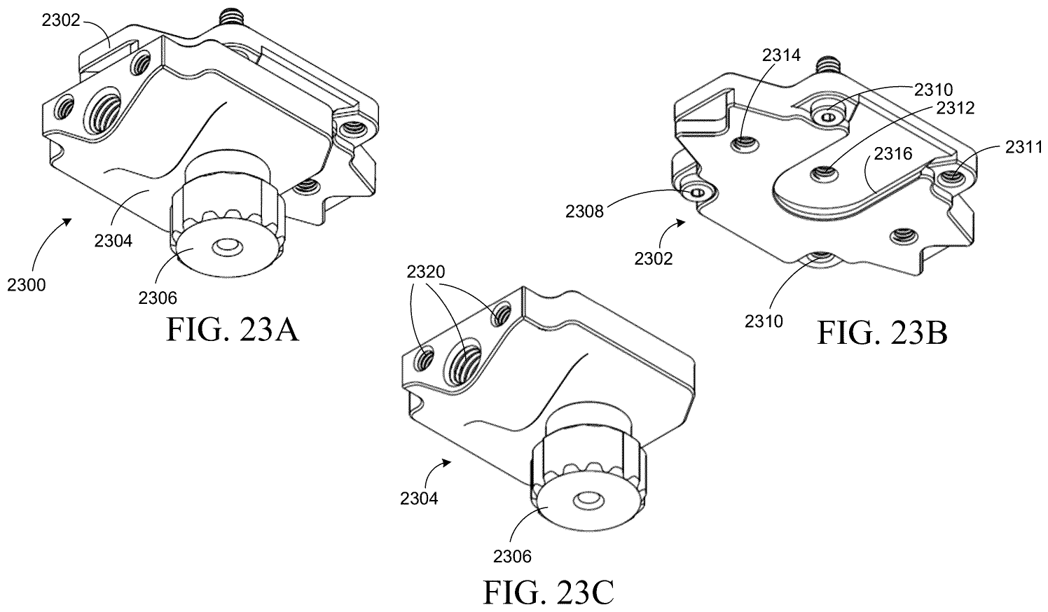

In some examples, a light reflector according to the present disclosure may be sufficiently large that the magnetic connection of FIG. 18 may not be sufficiently secure to hold two or more light reflectors together in an extended structure. As such, in some such examples, two or more light reflectors can be connected using brackets. FIG. 22 shows an example of an extended structure 2000 in which four light reflectors 2201, 2202, 2204, 2206 are held together by brackets. The backsides of the light reflectors 2201, 2202, 2204, 2206 are shown in FIG. 22. In this example, different types of brackets are used in different locations of the extended structure. Brackets 2210 and 2212 of a first type are used to connect first and second opposing outer edges of the panels of the extended structure. Brackets 2214 and 2216 of a second type are used to connect third and fourth opposing outer edges of panels of the extended structure. Brackets 2214, 2216 of the second type also act as attachment points for a yoke 2217. The yoke 2217 includes a stand mount 2218 for convenient mounting to a stand or other suitable support. An example of a bracket that can be used as brackets 2214, 2216 is described in more detail with reference to FIG. 23A-C.

Two pair of brackets 2220, 2222 of a third type are joined to the light reflectors 2201, 2202, 2204, 2206 in a center of the extended structure. The brackets of the third type 2220, 2222 respectively each includes a bar 2224, 2226 that extends to the brackets of the second type 2214, 2216. The bar 2224 can include holes that allow various accessories, such as a handle 2227, to be attached.

As mentioned above, the brackets of the second type 2214, 2216 also serve as attachment points for the yoke 2217. The attachment points of the yoke 2217 to the brackets of the second type 2214, 2216 can allow the extended structure of the light panels 2201, 2202, 2204, 2206 to swivel relative to a stand for pitch adjustment, as indicated by arrow 2228. Further, the stand mount can allow the extended structure of the light panels 2201, 2202, 2204, 2206 to swivel relative to a stand in an orthogonal direction to the yoke attachment points for yaw adjustment. This allows a pitch and a yaw of the extended structure of the light panels 2201, 2202, 2204, 2206 to be conveniently adjusted. Further, a brake 2230 can be provided to secure the extended structure of the light panels 2201, 2202, 2204, 2206 at a desired pitch.

In the example of FIG. 22, each of the light reflectors 2201, 2202, 2204, 2206 includes a diagonal support member, such as diagonal support member 2232 for light reflector 2201. The diagonal support members can help provide rigidity to the light reflectors. The diagonal support member 2232 is connected to the bracket of the third type 2222 and also to a corner of the light reflector 2201. While the disclosed light reflectors are rectangular, light reflectors of other shapes also can be used, and brackets can be configured to connect the light reflectors in suitable locations.

FIGS. 23A-C show an example of a bracket 2300 that is suitable for use as second brackets 2214 and 2216 of FIG. 22. The bracket 2300 includes a base 2302, a releasable clamp 2304, and a knob bolt 2306 (or other suitable bracket) to connect the releasable clamp 2304 to the base 2302. The base 2304 is shown in more detail in FIG. 23B. The base includes mounting holes 2308, 2309, 2310, 2311 to mount the base 2304 to adjacent light reflectors. The base further includes a hole 2312 to receive the knob bolt 2306. The base further includes an inset portion 2316 configured to receive a rail, such as the rail 2224 of FIG. 22.

The releasable clamp 2304, shown in FIG. 23C, can be secured to the base 2302 with the knob bolt 2306 to clamp the rail and thereby secure the rail to an extended structure of two or more light reflectors. The releasable clamp 2304 also includes yoke mounting holes 2320. The yoke mounting hole allows a yoke, such as the yoke 2217 of FIG. 22, to be attached to the releasable clamp 2304. The releasable clamp 2304 can be removed from the base 2303 to allow a yoke to be conveniently removed from an extended structure. In other examples, any other suitable mechanism than the knob bolt 2306 can be used to hold a releasable clamp 2304 to a base 2302.

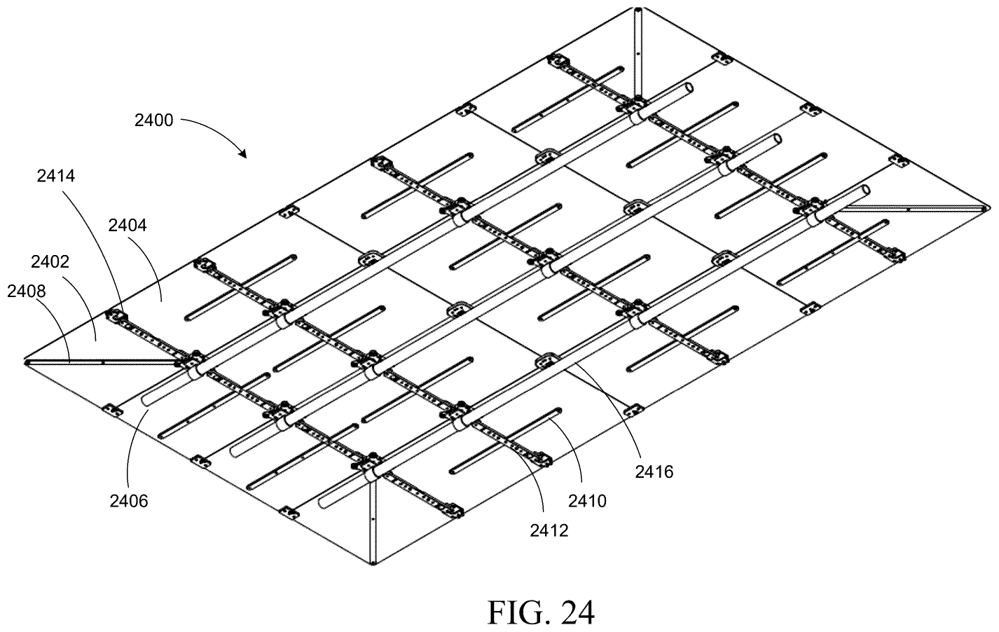

The disclosed light reflectors can be connected to form larger extended structures in some examples. FIG. 24 shows an example extended structure 2400 in which twenty eight light reflectors, including light reflectors 2402, 2404, and 2406, are connected in a 7×4 array using brackets, such as those described above for the example of FIG. 22. In this example, various diagonal braces 2408 and inter-panel braces 2410 (braces that extend across portions of two or more panels) can be used to provide rigidity. Further, bars 2412 can extend between brackets that are used to hold adjacent light reflectors together, such as bracket 2414 that holds light reflectors 2402 and 2404 together. The extended structure 2400 further includes brackets that hold speed rails 2416, which are rails used in studio lighting applications. The speed rails 2416 provide attachment points for mounting the extended structure 2400 to one or more stands or other supports. The speed rails 2416 also provide additional structural support for the extended structure 2400.

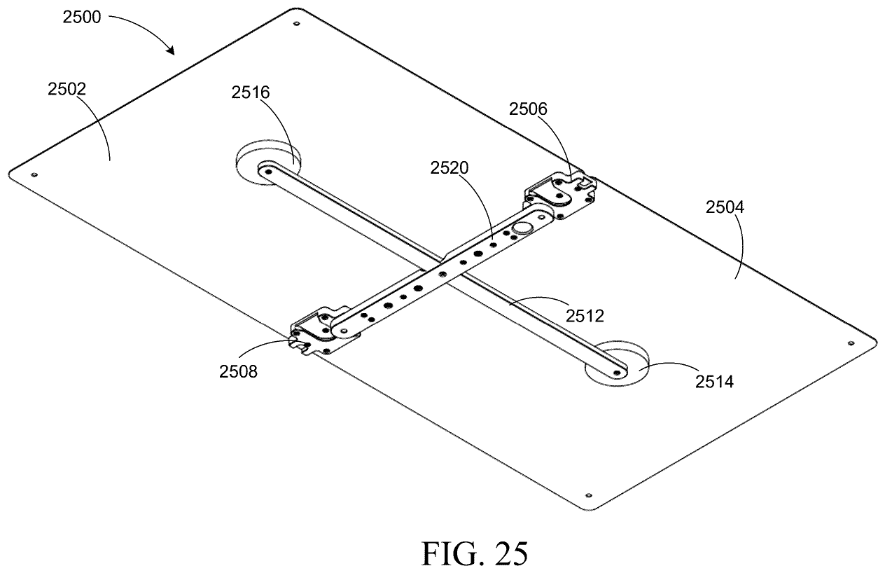

FIG. 25 shows an example of a smaller extended structure 2500 formed from two light reflectors 2502, 2504. The light reflectors 2502, 2504 are held together by brackets 2506 and 2508. In some examples, the brackets 2506 and 2508 take the form of the base 2302 of the bracket 2300 of FIGS. 23A-C. A bar 2510 can extend between the brackets 2506 and 2508. As described above for other examples, the bar 2510 includes mounting holes to which accessories, such as a handle or a stand mount, can be attached. Further, an inter-panel brace 2512 can extend across portions of the two light reflectors 2502, 2504. The inter-panel brace 2512 can be mounted to the light reflectors 2502, 2504 using magnetic bases 2514, 2516, or using any other suitable attachment mechanism in other examples.

Descriptions of technical features or aspects of an exemplary configuration of the disclosure should typically be considered as available and applicable to other similar features or aspects in another exemplary configuration of the disclosure. Accordingly, technical features described herein according to one exemplary configuration of the disclosure may be applicable to other exemplary configurations of the disclosure, and thus duplicative descriptions may be omitted herein.

Methods of making and of using the light reflector or light reflector unit, and components thereof, are within the scope of the present invention.

Although limited embodiments of lighting systems, and methods of operation thereof, have been specifically described and illustrated herein, many modifications and variations will be apparent to those skilled in the art. The disclosure is also defined in the following claims.

### EXAMPLE EMBODIMENTS

The following are numbered example embodiments of the apparatuses, devices, systems, and methods related to a lighting system for reflecting light. The below listing of examples or any other examples disclosed herein may be combined in whole or in part. Elements of the examples disclosed herein are not limiting.

Example 1. A light reflector including a reflector body that is opaque and has a front surface. The light reflector also includes a coating applied at least to the front surface of the reflector body. The coating is configured to reflect and diffuse light from one or more light sources. One or more of the coating or the reflector body comprises a ferromagnetic material.

Example 2. The light reflector, system, device, apparatus, and method of any of the above Examples alone or in combination, wherein the light reflector further includes one or more lighting devices removably connected to the front surface of the light reflector.

Example 3. The light reflector, system, device, apparatus, and method of any of the above Examples alone or in combination, wherein the light reflector is configured to reflect the reflected light along a reflected light axis, and each lighting device is configured to emit light along an artificial light axis that is parallel to the reflected light axis of the reflected light from the reflector body, thus simultaneously mixing the reflected light and the artificial light from each lighting device to create a mixed lighting effect on a subject.

Example 4. The light reflector, system, device, apparatus, and method of any of the above Examples alone or in combination, wherein each lighting device includes a housing, a light housed within the housing, and one or more magnets disposed within the housing and configured to magnetically engage with the reflector body to removably connect the housing onto the front surface of the reflector body.

Example 5. The light reflector, system, device, apparatus, and method of any of the above Examples alone or in combination, wherein the light reflector further includes a diffractor removably connected to the reflector body. The diffractor is configured to create a shadow within the reflected light, accordingly, forming an umbra, penumbra, and antumbra in the reflected light.

Example 6. The light reflector, system, device, apparatus, and method of any of the above Examples alone or in combination, wherein the diffractor is magnetically connected to the reflector body a magnetic base.

Example 7. The light reflector, system, device, apparatus, and method of any of the above Examples alone or in combination, wherein the reflector body further comprises a diffractor hole, the diffractor comprises a cover head and a rod extending rearwardly from the cover head, the rod of the diffractor is configured to extended through the diffractor hole of the reflector body when the diffractor is assembled to the reflector body.

Example 8. The light reflector, system, device, apparatus, and method of any of the above Examples alone or in combination, wherein the diffractor is configured to be adjustable by sliding the rod relative to the reflector body to accordingly move the cover head closer to or further away from the front surface of the reflector body to thereby respectively increase or decrease the size of the shadow created by the diffractor.

Example 9. The light reflector, system, device, apparatus, and method of any of the above Examples alone or in combination, wherein the reflector body comprises steel.

Example 10. The light reflector, system, device, apparatus, and method of any of the above Examples alone or in combination, wherein the coating defines a matte finish.

Example 11. The light reflector, system, device, apparatus, and method of any of the above Examples alone or in combination, wherein the coating comprises an adhesive, a plurality of first reflective particles, and a plurality of second reflective particles which are less reflective than the first reflective particles.

Example 12. The light reflector, system, device, apparatus, and method of any of the above Examples alone or in combination, wherein the front surface of the reflector body is substantially flat.

Example 13. The light reflector, system, device, apparatus, and method of any of the above Examples alone or in combination, wherein the reflector body comprises a thin rectangular plate.

Example 14. The light reflector, system, device, apparatus, and method of any of the above Examples alone or in combination, wherein the diffractor is rotatable relative to the rod.

Example 15. The light reflector, system, device, apparatus, and method of any of the above Examples alone or in combination, wherein the rod projector from the cover head of the diffractor is positionable relative to the reflector body via magnetic forces.

Example 16. The light reflector, system, device, apparatus, and method of any of the above Examples alone or in combination, wherein the rod projector from the cover head of the diffractor is positionable on relative to the reflector body via at least one magnet located in or on a rear mounting bracket.

Example 17. The light reflector, system, device, apparatus, and method of any of the above Examples alone or in combination, wherein the reflector body comprises a plurality of holes located adjacent or proximate the plurality of edges of the reflector body.

Example 18. The light reflector, system, device, apparatus, and method of any of the above Examples alone or in combination, wherein the reflector body comprises a plurality of edge through holes located adjacent or proximate the plurality of edges of the reflector body and a plurality of holes located radially inwardly of the edge through holes.

Example 19. The light reflector, system, device, apparatus, and method of any of the above Examples alone or in combination, wherein the plurality of edge through holes are configured to mechanically fasten with main mounting brackets or secondary mounting brackets.

Example 20. The light reflector, system, device, apparatus, and method of any of the above Examples alone or in combination, wherein the reflector is multi-sided.

Example 21. The light reflector, system, device, apparatus, and method of any of the above Examples alone or in combination, wherein the reflector body is generally rectangular or generally square in shape.

Example 22. The light reflector, system, device, apparatus, and method of any of the above Examples alone or in combination, wherein the reflector body includes at least some ferrous materials.

Example 23. The light reflector, system, device, apparatus, and method of any of the above Examples alone or in combination, wherein the reflector body is structurally rigid and can support one or more lighting devices directly thereon.

Example 24. The light reflector, system, device, apparatus, and method of any of the above Examples alone or in combination, wherein one or more lighting devices can magnetically attach to the reflector body.

Example 25. The light reflector, system, device, apparatus, and method of any of the above Examples alone or in combination, further comprising a lighting device magnetically attached to the reflector body such that a light beam emitted by the lighting device projects toward the front of the reflector body or away from the front of the reflector body.

Example 26. The light reflector, system, device, apparatus, and method of any of the above Examples alone or in combination, wherein the magnet is a neodymium magnet.

Example 27. A lighting system comprising a plurality of light reflectors. Each light reflector includes a reflector body composed of a ferrous material, the reflector body being opaque and having a front surface and a back surface, and a coating applied to the front surface of the reflector body. The coating is configured to reflect and diffuse light from one or more light sources. The lighting system further includes a bracket assembly that includes at least one bracket configured to removably connect to the back surface of each light reflector and secure the plurality of light reflectors together to form a light reflector unit.

Example 28. The light reflector, system, device, apparatus, and method of any of the above Examples alone or in combination, wherein the at least one bracket comprises a bracket body and a plurality of magnets connected to the bracket body, the plurality of magnets configured to magnetically attract the plurality of light reflectors to removably magnetically connect the at least one bracket to the plurality of light reflectors.

Example 29. The light reflector, system, device, apparatus, and method of any of the above Examples alone or in combination, wherein the bracket body has a plurality of recessed holes for receiving a magnet in each of the recessed holes in a recessed manner.

Example 30. The light reflector, system, device, apparatus, and method of any of the above Examples alone or in combination, wherein each magnet is recessed below an outer surface of the bracket body.

Example 31. The light reflector, system, device, apparatus, and method of any of the above Examples alone or in combination, wherein the bracket is surrounded by an outer cover, which covers the magnets.

Example 31. The light reflector, system, device, apparatus, and method of any of the above Examples alone or in combination, wherein the reflector body of each light reflector of the plurality of light reflectors comprises fastener holes configured to receive fasteners therethrough, and the at least one bracket further comprises a plurality of mounting holes within the bracket body. The plurality of mounting holes in the bracket body are configured to align with the corresponding fastener holes of the corresponding light reflectors for receiving fasteners therethrough for fastening the at least one bracket to the plurality of light reflectors.

Example 32. The light reflector, system, device, apparatus, and method of any of the above Examples alone or in combination, wherein each of the plurality of light reflectors has an edge and wherein the edge of one light reflector abuts an edge of another reflector to from an array of light reflectors that are held together with magnets generating magnetic forces.

Example 33. The light reflector, system, device, apparatus, and method of any of the above Examples alone or in combination, wherein the array of light reflectors are held together with both magnetic forces and mechanical fasteners.

Example 34. The light reflector, system, device, apparatus, and method of any of the above Examples alone or in combination, wherein the bracket body is multi-sided.

Example 35. The light reflector, system, device, apparatus, and method of any of the above Examples alone or in combination, wherein the array of light reflectors combine to form a generally rectangular shaped body having a plurality of seams in between the light reflectors.

Example 36. The light reflector, system, device, apparatus, and method of any of the above Examples alone or in combination, wherein the array of light reflectors combine to form a generally rectangular shaped body that are held by a bracket assembly comprising a main bracket and a plurality of secondary brackets, and wherein the main bracket has a different shape than each of the plurality of secondary brackets.

Example 37. The light reflector, system, device, apparatus, and method of any of the above Examples alone or in combination, wherein the main bracket has at least four magnets to magnetically couple to a corner of each of four light reflectors.

Example 37. The light reflector, system, device, apparatus, and method of any of the above Examples alone or in combination, wherein the bracket assembly includes a main mounting bracket configured to couple corners of adjoining light reflectors of the plurality of light reflectors. The main bracket comprises an attachment point that is configured for connecting the light reflector unit to a support structure.

Example 38. The light reflector, system, device, apparatus, and method of any of the above Examples alone or in combination, wherein the bracket assembly further includes at least one secondary mounting bracket configured to couple sides of the adjoining light reflectors of the plurality of light reflectors.

Example 39. The light reflector, system, device, apparatus, and method of any of the above Examples alone or in combination, wherein each lighting device is configured to emit light along an artificial light axis that is common to the reflected light axis of the reflected light from the reflector body, thus simultaneously mixing the reflected light and the artificial light from each lighting device to create a mixed lighting effect on a subject.

Example 40. The light reflector, system, device, apparatus, and method of any of the above Examples alone or in combination, wherein a light reflector unit having a front and a back and formed by joining a plurality of light reflectors with magnets has both a lighting device and a diffractor mounted to the front of the light reflector unit.

Example 41. The light reflector, system, device, apparatus, and method of any of the above Examples alone or in combination, wherein a light reflector unit is combined with a gobo, cucoloris, eggcrate or grid, optics, prisms, other diffusion materials such as fabric or silicon, and/or filters or gels.

Example 42. The light reflector, system, device, apparatus, and method of any of the above Examples alone or in combination, wherein the coating comprises a paint containing the ferromagnetic material.

Example 43. The light reflector, system, device, apparatus, and method of any of the above Examples alone or in combination, further comprising a light source coupled to a backside of the light reflector, the light source having a light emitting portion configured to illuminate at least a portion of a front side of the light reflector.

Example 44. The light reflector, system, device, apparatus, and method of any of the above Examples alone or in combination, further comprising a yoke mounted to the lighting system with a bracket comprising a releasable clamp.

Example 45. The light reflector, system, device, apparatus, and method of any of the above Examples alone or in combination, wherein the yoke comprises a stand mount.

The light reflector, system, device, apparatus, and method of any of the above Examples alone or in combination, further comprising a handle.

The light reflector, system, device, apparatus, and method of any of the above Examples alone or in combination, further comprising a magnetically attached handle.

The light reflector, system, device, apparatus, and method of any of the above Examples alone or in combination, wherein a first light reflector of a plurality of light reflectors is attached to a second light reflector of the plurality of light reflectors with a hinge mechanism. The light reflector, system, device, apparatus, and method of any of the above Examples alone or in combination, wherein the hinge mechanism is magnetically attached to the first light reflector and the second light reflector. cm 1. A light reflector comprising:
a reflector body, the reflector body being opaque and having a front surface; and

a coating applied to the front surface of the reflector body, the coating configured to reflect and diffuse light from one or more light sources, wherein one or more of the reflector body or the coating comprises a ferromagnetic material.

2. The light reflector of claim 1, further comprising one or more lighting devices removably connected to the front surface of the light reflector.

3. The light reflector of claim 2, wherein:
the light reflector is configured to reflect the reflected light along a reflected light axis; and
each lighting device is configured to emit light along an artificial light axis that is parallel to the reflected light axis of the reflected light from the reflector body, thus simultaneously mixing the reflected light and the artificial light from each lighting device to create a mixed lighting effect on a subject.

4. The light reflector of claim 3, wherein each lighting device comprises:
a housing;
a light housed within the housing; and
one or more magnets disposed within the housing and configured to magnetically engage with the reflector body to removably connect the housing onto the front surface of the reflector body.

5. The light reflector of claim 1, further comprising a diffractor removably connected to the reflector body, wherein the diffractor is configured to create a shadow within the reflected light, accordingly, forming an umbra, penumbra, and antumbra in the reflected light.

6. The light reflector of claim 5, wherein the diffractor is magnetically connected to the reflector body via a magnetic base.

7. The light reflector of claim 5, wherein:
the reflector body further comprises a diffractor hole;
the diffractor comprises an annular head and a rod extending rearwardly from the head;
the rod of the diffractor is configured to extended through the diffractor hole of the reflector body when the diffractor is assembled to the reflector body; and
the diffractor is configured to be adjustable by sliding the rod relative to the reflector body to accordingly translate the head closer to or further away from the front surface of the reflector body to thereby respectively increase or decrease the size of the shadow created by the diffractor.

8. The light reflector of claim 1, wherein the reflector body comprises steel.

9. The light reflector of claim 1, wherein the coating defines a matte finish.

10. The light reflector of claim 9, wherein the coating comprises an adhesive, a plurality of first reflective particles, and a plurality of second reflective particles which are less reflective than the first reflective particles.

11. The light reflector of claim 9, wherein the coating comprises a paint containing the ferromagnetic material.

12. The light reflector of claim 9, further comprising a light source coupled to a backside of the light reflector, the light source having a light emitting portion configured to illuminate at least a portion of a front side of the light reflector.

13. A lighting system comprising:
a plurality of light reflectors, each light reflector comprising:
a reflector body, the reflector body being opaque and having a front surface and a back surface; and
a coating applied to the front surface of the reflector body, the coating configured to reflect and diffuse light from one or more light sources, wherein one or more of the reflector body or the coating comprises a ferromagnetic material; and
a bracket assembly comprising at least one bracket configured to removably connect to the back surface of each light reflector and secure the plurality of light reflectors together to form a light reflector unit.

14. The lighting system of claim 13, wherein the at least one bracket comprises a bracket body and a plurality of magnets internally disposed within the bracket body, the plurality of magnets configured to magnetically engage with the plurality of light reflectors to removably connect the at least one bracket to the plurality of light reflectors.

15. The lighting system of claim 13, wherein:
the reflector body of each light reflector of the plurality of light reflectors comprises fastener holes configured to receive fasteners therethrough; and
the at least one bracket further comprises a plurality of mounting holes within the bracket body, the plurality of mounting holes in the bracket body configured to align with corresponding fastener holes of corresponding light reflectors for receiving fasteners therethrough for fastening the at least one bracket to the plurality of light reflectors.

16. The lighting system of claim 13, the bracket assembly comprises:
a main mounting bracket configured to couple corners of adjoining light reflectors of the plurality of light reflectors, the main bracket comprising an attachment point that is configured for connecting the light reflector unit to a support structure; and
at least one secondary mounting bracket configured to couple sides of the adjoining light reflectors of the plurality of light reflectors.

17. The lighting system of claim 13, further comprising a yoke mounted to the lighting system with a bracket comprising a releasable clamp.

18. The lighting system of claim 17, wherein the yoke comprises a stand mount.

19. The lighting system of claim 13, further comprising a handle coupled with the bracket.

20. The lighting system of claim 13, further comprising a magnetically attached handle.

21. The lighting system of claim 13, wherein a first light reflector of the plurality of light reflectors is attached to a second light reflector of the plurality of light reflectors with a hinge mechanism.

22. The lighting system of claim 21, wherein the hinge mechanism is magnetically attached to the first light reflector and the second light reflector.
